(19) United States
(12) Patent Application Publication
(10) Pub. No.: US 2026/0207315 A1
(43) Pub. Date: Jul. 23, 2026

(54) METERED DOSE MATERIAL DISPENSER AND METHODS OF USE

(71) Applicant: Coolhouse Sourcing LLC, Minneapolis, MN (US)

(72) Inventor: Jolie Chitwood, Minneapolis, MN (US)

(21) Appl. No.: 19/450,568

(22) Filed: Jan. 15, 2026

Related U.S. Application Data
(60) Provisional application No. 63/746,936, filed on Jan. 18, 2025.

(51) Int. Cl. A61D 7/00

(52) U.S. Cl. CPC A61D 7/00

(57) ABSTRACT

Material dispensers and methods of using such dispensers to administer material to animals are provided. The dispenser can include a body having a chamber. The body can include detent(s) or protrusion(s), and can define aperture(s) or a permeable portion for dispensing material. The dispenser can include a base or an intermediate rotary actuator rotatably couplable to the body. The base or actuator can include detent(s) or protrusion(s). Interaction between the detent(s) or protrusion(s) of the base or actuator and body can provide feedback when the base or actuator is rotated relative to the body. The dispenser can include a shaft extending along the chamber, and a plunger assembly rotatably couplable to the shaft. Rotation of the base or actuator relative to the body can enable shaft rotation and translation of the plunger assembly along the shaft, thereby forcing material out of the dispenser to an animal.

### CROSS REFERENCE TO RELATED APPLICATION

This application claims priority under 35 U.S.C. § 119 to U.S. Provisional Application No. 63/746,936, entitled “METERED DOSE MEDICAMENT DISPENSER”, filed Jan. 18, 2025, the disclosure of which is incorporated herein by reference in its entirety.

### TECHNICAL FIELD

The present disclosure generally relates to material dispensing devices and methods of using such devices. More particularly, the present disclosure relates to material dispensing devices and methods of using such devices to administer a metered amount or dose of material to an animal.

### BACKGROUND

Administering materials such as supplements and medicaments to animals, especially finicky animals such as cats and small dogs, presents unique challenges for animal owners and veterinarians alike. Ensuring that animals receive a correct dose of a supplement or drug is crucial for the health and well-being of the animals. Common methods include mixing the material with food or administering the material into the mouth of the animals using a syringe. Both methods are known to be imprecise as to the amount dispensed to the animals, and are generally stressful for the animal and the individual administering the material.

The present disclosure provides metered dose material dispensing devices and methods of using such devices that address difficulties associated with dispensing materials to animals. The present disclosure describes and illustrates these devices, methods, and techniques, along with various advantages they provide over conventional techniques for administering materials from packaging devices and solutions.

### SUMMARY

Non-limiting examples of the present disclosure provide a first method of administering material to an animal using a metered dose material dispenser. The method can include providing a metered dose material dispenser as shown and described herein. The method can further include rotating a base (rotary or intermediate finger wheel in alternative examples) of the dispenser relative to a body of the dispenser from a first position to a second position, thereby causing a shaft of the dispenser to rotate and a plunger of the dispenser to translate within the body, to force a first amount or dose of material out of the dispenser. The method can further include administering the first amount or dose of material to an animal. In some examples, the second position can be offset from the first position by a quarter-turn or another fractional turn measurement. In some examples where the dispenser comprises a rectangular prismatic or cuboid geometry, movement between the first and second positions can represent a quarter-turn relative to the full rotation of the base (e.g., a 90-degree rotation with a 360-degree full rotation available).

Non-limiting examples of the present disclosure provide a second method of administering material to an animal using a metered dose material dispenser. The method can include providing a metered dose material dispenser as shown and described herein. The method can further include rotating a base of the dispenser relative to a body of the dispenser from a first position to a second position, thereby causing a shaft of the dispenser to rotate and a plunger of the dispenser to translate within the body, to force a first amount or dose of material out of the dispenser. The method can further include rotating the base relative to the body from the second position to a third position, thereby causing the shaft to rotate further and the plunger to translate further within the body to force a second amount or dose of material out of the dispenser. The method can further include rotating the base relative to the body from the third position to a fourth position, thereby causing the shaft to rotate further and the plunger to translate further within the body to force a third amount or dose of material out of the dispenser. The method can further include rotating the base relative to the body from the fourth position to the first position, thereby causing the shaft to rotate further and the plunger to translate further within the body to force a fourth amount or dose of material out of the dispenser.

In some examples, the first, second, third, and fourth positions can be offset by 90-degrees or another angular measurement. For example, using a 90-degree offset rotation from the first position to the second, third, and fourth positions, and from the fourth position back to the first position, can represent a full 360-degree rotation of the dispenser base relative to the dispenser body.

In some examples, the second method can further include administering a first and subsequent doses of material individually or with two or more doses of material in combination. In some examples of the first or second methods, administering the doses of material can include at least one of extruding the dose(s) onto a body part of the animal, extruding the dose(s) into or around a mouth of the animal, extruding the dose(s) into a container, extruding the dose(s) onto an animal toy, and extruding the dose(s) onto a surface of the dispenser and allowing the animal to consume the dose(s) off the surface.

Non-limiting examples of the present disclosure provide a metered dose material dispenser. The dispenser can include a body having a chamber extending between a first body end and a second body end. The body can further include a first plurality of protrusions or projections extending outward from the second body end. The dispenser can further include a base rotatably couplable to the body. The base can include a second plurality of protrusions or projections arranged around an interior base wall. The dispenser can further include a shaft extending along the chamber between the first and second ends, a plunger assembly rotatably couplable to the shaft within the chamber, and a lid couplable to the body and having one or more apertures or a permeable portion for dispensing material from the dispenser. The base can be configured to rotate relative to the body to enable simultaneous rotation of the shaft. This can enable translation of the plunger assembly along the shaft toward the second end, thereby forcing material through the chamber and out of the one or more apertures or the permeable portion.

In some examples, the base can be configured to rotate in individual fractional turns (e.g., quarter turns). An individual fractional turn can be signaled or otherwise indicated by a visual, audible, or tactile indication caused by contact between the first and second pluralities of protrusions. In some examples, the metered dose material dispenser can employ a detachable lid with one or more apertures or a permeable portion through which a dose is dispensed. In some examples, the metered dose material dispenser does not employ a detachable lid and instead has a unitary body having a flattened end with one or more apertures or a permeable portion through which a dose is dispensed. In some examples, the shaft can be externally threaded between a first shaft end and a second shaft end (e.g., the shaft can be entirely or partially threaded between the first and second shaft ends).

In some examples, the metered dose material dispenser can include a rotary such as an intermediate finger wheel positioned along the body. The rotary or finger wheel can include a plurality of serrations along a periphery surface and can be configured to operate substantially the same as the base (e.g., rotate to dispense material from the dispenser, provide an indication that an amount or dose of material was dispersed from the dispenser, and that the rotary or finger wheel was rotated relative to the body). The rotary or finger wheel can be rotated by a user in the same manner as with rotation of the base. The plurality of serrations can indicate one or more rotations of the rotary or finger wheel relative to the body.

In some examples, the plunger assembly can include internal threads that interact with external threads of the shaft. In some examples, the lid can be characterized as a material dispensing lid or cap placed over the body and configured to dispense material from the body to an animal. In some examples, the metered dose material dispenser can comprise a single detent and a plurality of protrusions configured to interact with each other to create a visual, audible, or tactile indication indicating rotation of the base relative to the body and administration of an amount or dose of material. In some examples, the metered dose material dispenser can comprise a plurality of detents and a single protrusion configured to interact with each other to create a visual, audible, or tactile indication indicating administration of an amount or dose of material.

In some examples, the base and the body can be separable such that a new body filled with a quantity of dispensing material can replace an old body exhausted of dispensing material. This enables a user to reuse several of the dispenser components when the body runs out of dispensing material. This advantageously limits material waste because only the body of the dispenser is typically replaced, rather than replacing the entire dispenser when the dispensing material is exhausted. In some examples, the dispenser can further include a cover positioned around the lid. The cover can include at least one post or peg configured for insertion into the one or more material dispensing apertures or permeable portion to block material flow from the chamber. In some examples, the components of the dispenser, such as the base and the body, can be aligned or substantially aligned on all sides, such that they comprise the same or approximately the same length and width dimensions (e.g., there is little or no overhang between the base and the body).

The above summary is not intended to describe each illustrated example or every implementation of the subject matter hereof. The FIGURES and the detailed description that follow more particularly exemplify various examples.

### BRIEF DESCRIPTION OF THE DRAWING

Subject matter hereof may be more completely understood in consideration of the following detailed description of various examples in connection with the accompanying FIGURES, in which:

FIG. 1A is a top perspective view of a metered dose material dispenser with a cover, according to examples of the present disclosure;

FIG. 1B is a bottom perspective view of the metered dose material dispenser of FIG. 1A;

FIG. 2A is a top view of the metered dose material dispenser of FIGS. 1A and 1B;

FIG. 2B is a bottom view of the metered dose material dispenser of FIGS. 1A through 2A;

FIG. 2C is a side view of the metered dose material dispenser of FIGS. 1A through 2B;

FIG. 3 is a top perspective view of the metered dose material dispenser of FIGS. 1A through 2C without a cover;

FIG. 4A is a top view of the metered dose material dispenser of FIG. 3;

FIG. 4B is a side view of the metered dose material dispenser of FIG. 3;

FIG. 5A is a top perspective view of the metered dose material dispenser of FIG. 3 in a rotated position;

FIG. 5B is a bottom perspective view of the metered dose material dispenser of FIG. 3 in a rotated position;

FIG. 6A is a top cutaway perspective view of the metered dose material dispenser of FIG. 3 with a plunger in a first position;

FIG. 6B is a top cutaway perspective view of the metered dose material dispenser of FIG. 3 with a plunger in a second position;

FIG. 6C is a side cutaway view of the metered dose material dispenser of FIG. 1A through 2C;

FIG. 7 are top and bottom perspective exploded views of the metered dose material dispenser of FIGS. 1A through 2C;

FIG. 8 is a method of administering material using the disclosed metered dose material dispensers of FIGS. 1A through 7;

FIG. 9A is a perspective view illustrating administering material to a foot or paw of an animal using the disclosed metered dose material dispensers of FIGS. 1A through 7;

FIG. 9B is a perspective view illustrating administering material to a mouth or facial feature of an animal using the disclosed metered dose material dispensers of FIGS. 1A through 7;

FIG. 9C is a perspective view illustrating administering material that an animal licks or consumes off of the disclosed metered dose material dispensers of FIGS. 1A through 7;

FIG. 9D is a perspective view illustrating administering material to a food container of an animal using the disclosed metered dose material dispensers of FIGS. 1A through 7; and

FIG. 9E is a perspective view illustrating administering material to an animal toy or play article using the disclosed metered dose material dispensers of FIGS. 1A through 7.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

Examples of the present disclosure include a metered dose material dispenser for administering material to an animal. The dispenser may include a body having a chamber extending between a first body end and a second body end. The body can further include a first plurality of protrusions extending outward from the second body end. The dispenser may further include a base rotatably couplable to the body. Alternatively, the dispenser may further include a rotary finger wheel instead of the base, and the finger wheel may be positioned at either end of the body or at an intermediate position along the body. The base may include a second plurality of protrusions arranged around an interior base wall. The dispenser may further include a shaft extending along the chamber between the first and second ends. The dispenser may further include a plunger assembly couplable to the shaft within the chamber, and a lid couplable to the body and having one or more apertures or a permeable portion for dispensing material.

In operation, the base or rotary finger wheel can be configured to rotate relative to the body to enable simultaneous rotation of the shaft. Rotation of the shaft can enable upward translation or movement of the plunger assembly along the shaft toward the second end of the body. Upward translation or movement of the plunger assembly forces or pushes material through the chamber and out of one or more apertures or a permeable portion to an animal for their consumption. During operation, the base or rotary finger wheel can be configured to rotate in individual fractional turns relative to the body (e.g., ¼ turn or about 90 angular degrees, ⅕ turn or about 72 angular degrees, ⅙ turn or about 60 angular degrees, ⅛ turn or about 45 angular degrees, 1/10 turn or about 36 angular degrees, 1/12 turn or about 30 angular degrees, and so on). Each individual fractional turn can be signaled or otherwise indicated by a visual, audible, or tactile indication, for example a clicking sound or a tactile element, caused by contact between the first and second pluralities of protrusions. Generally speaking, the visual, audible, or tactile indication can be indicative of contact between two structures such as a pair of typically planar, panel-like protrusions. In some examples, the metered dose material dispenser can comprise a single detent and a plurality of protrusions configured to interact with each other to create a visual, audible, or tactile indication indicating administering an amount or dose of material. In some examples, the metered dose material dispenser can comprise a plurality of detents and a single protrusion configured to interact with each other to create a visual, audible, or tactile indication indicating administering an amount or dose of material.

Accordingly, dispensers of the present disclosure can be configured to provide a metered amount or dose of material to an animal based on visual, audible, or tactile indications resulting from contact between the individual dispenser components. The visual, audible, or tactile indication can be correlated to a predetermined amount of extruded material so that a user such as an animal owner or a veterinarian can measure the amount or dose of material administered to an animal. This is especially advantageous in situations where a precise amount or dose of material, for example a supplement or medicament, must be provided to an animal. By correlating a visual, audible, or tactile indication with an extruded amount or dose of material, users can administer precise amounts of material to an animal under their care.

Before turning to the FIGURES, which illustrate certain examples in detail, it should be understood that the present disclosure is not limited to the details or methodology set forth in the description or illustrated in the FIGURES. It should also be understood that the terminology used herein is for the purpose of description only and should not be regarded as limiting. Common definitions are generally intended for the terminology used herein unless a specific definition is provided. In the case of a term having a common definition and a specific definition provided herein, the term should be construed according to its specific definition.

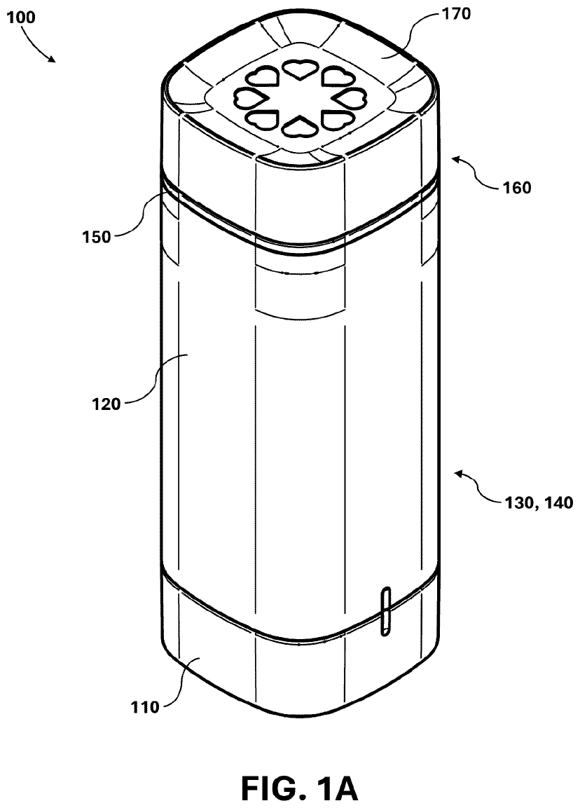

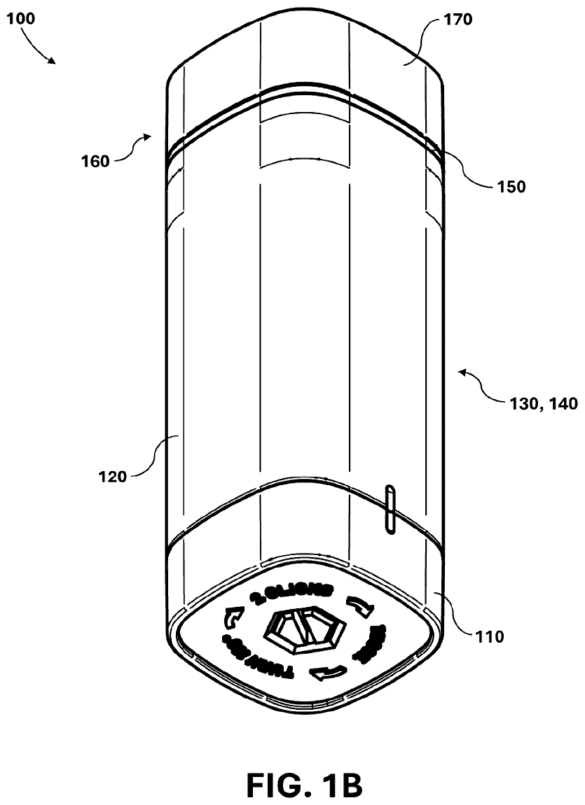

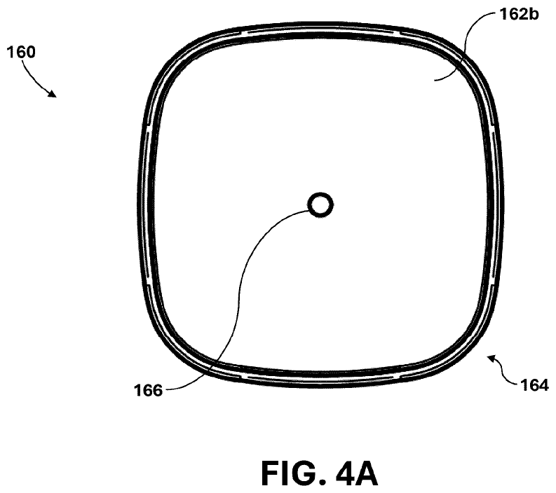

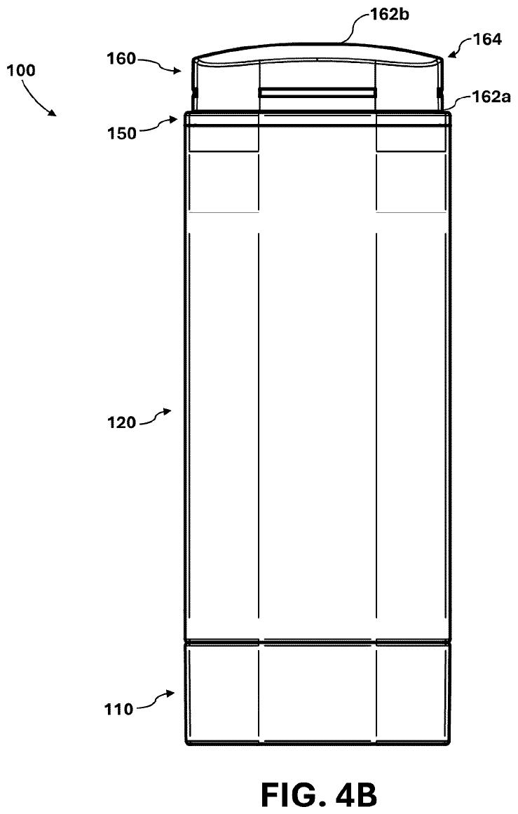

FIGS. 1A through 7 depict a metered dose material dispenser 100 according to examples of the present disclosure.

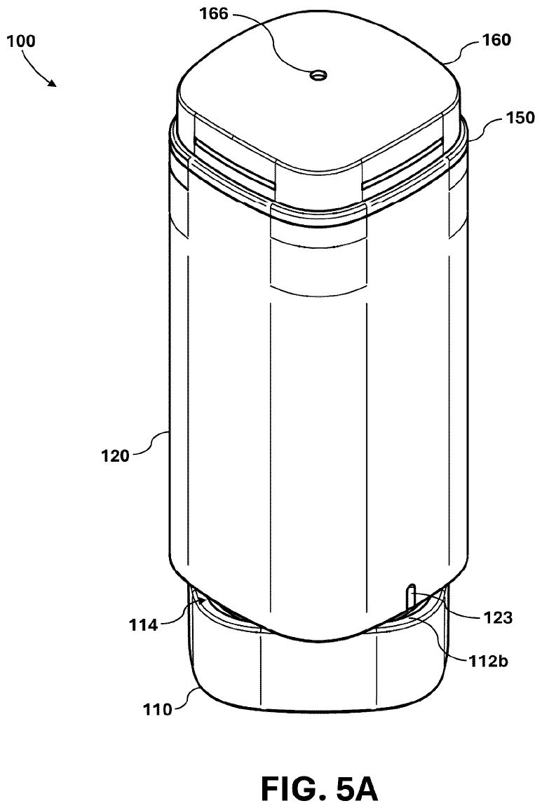

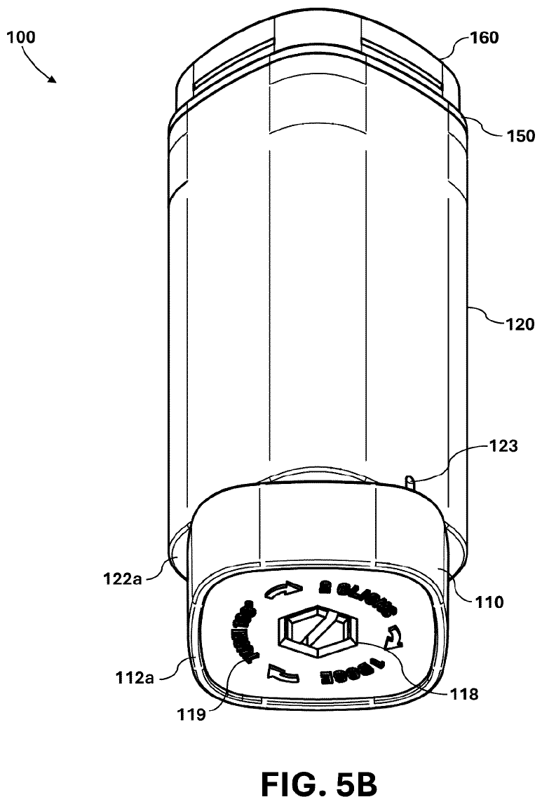

Referring now to FIGS. 1A and 1B, metered dose material dispenser 100 may include a base 110 rotatably couplable to a body 120 (as illustrated particularly in FIGS. 5A and 5B), a rotatable shaft assembly 130 received within the body 120, a plunger assembly 140 received within the body 120 and operably couplable to the shaft assembly 130, a bezel assembly 150 operably couplable to the body 120, a lid 160 operably couplable to the bezel assembly 150 and configured to dispense material from the body 120, and optionally a cover 170 positioned around the lid 160 when the dispenser 100 is not in operation. Dispenser 100 is generally configured to administer or dispense a metered or controlled amount or dose of material to an animal such as a cat or a dog. Controlled material dispensing can be performed by rotating the base 110 relative to the body 120 which causes the plunger assembly 140 to translate along a shaft 132 of the shaft assembly 130, thereby pushing or forcing a predetermined amount or dose of material through the body 120 and out of the lid 160. Continued rotation of base 110 enables successive amounts of predetermined amounts of material to be extruded from the lid 160. The predetermined material amount may range from approximately 0.25 to 2 grams in certain examples, though other predetermined amounts less than or greater than this range are contemplated by the present disclosure.

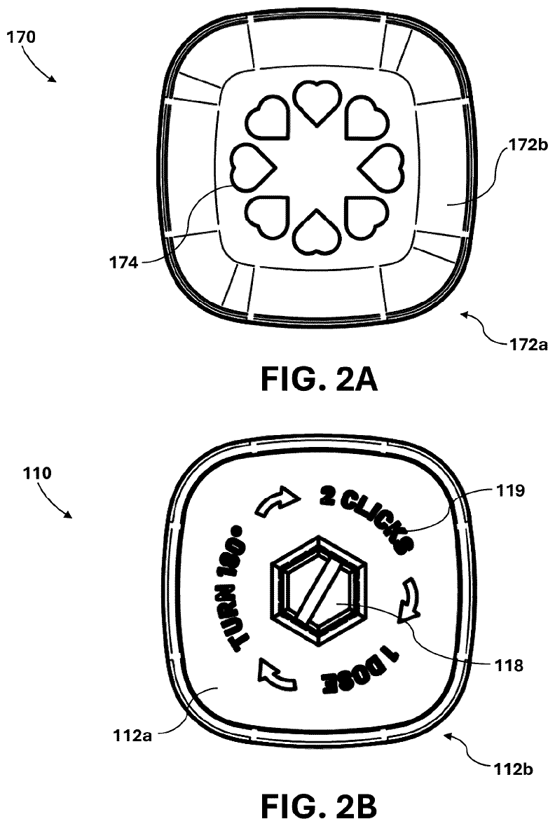

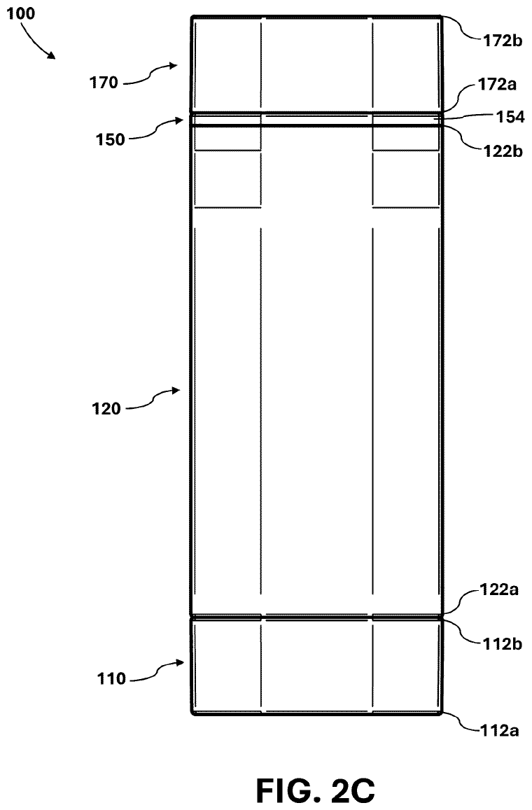

Referring now to FIGS. 2B, 2C, 3, and 5A through 7, dispenser 100 can include a base 110 having a generally rectangular prismatic or cuboid geometry extending between a first, closed base end 112a and a second, open base end 112b. In other examples, base 110 can comprise a generally cylindrical, triangular, conical, pyramidal, spherical, or other polygonal geometry. Base 110 generally comprises a thin-walled structure having exterior and interior side surfaces or walls. Base 110 generally comprises a hollow region 114 extending between the first and second base ends 112a,b. Base 110 can be constructed from a variety of materials including polymers (e.g., polypropylene, polyethylene, polycarbonate, acrylonitrile butadiene styrene), metals (e.g., aluminum), ceramics, fibers, and composites thereof. Base 110 can be manufactured using any suitable subtractive or additive manufacturing process, for example extrusion processes like injection molding or additive manufacturing.

Base 110 can further comprise a first plurality of protrusions 116 couplable to and arranged around an interior base wall. The first plurality of protrusions 116 may extend inward toward the hollow region 114 from the interior base wall. In some examples, base 110 can comprise four protrusions 116 arranged equidistant or approximately equidistant around the interior base wall. In other examples, the number of protrusions 116 may be less than or greater than four to change the predetermined amount or dose of material dispensed through lid 160. The first plurality of protrusions 116 can be integrally formed during initial manufacturing of base 110, or added to base 110 after initial manufacturing using any known fixation or coupling process (e.g., adhesives, welding, fasteners such as snap fits, magnets, staples, etc.).

The first plurality of protrusions 116 can be configured to interact with a second plurality of protrusions 128 of body 120 during operation of dispenser 100. The first plurality of protrusions 116 can surround a post 117 positioned in a centrally located area of the hollow region 114. The post 117 can generally be configured to interact with a cog structure 138 of shaft assembly 130 during operation of dispenser 100. Post 117 generally extends through the hollow region 114 from a first end proximate a base indentation 118 in a bottom surface of base 110, to a second end located a distance beyond the first end. Post 117 may include a hollow region connected to the base indentation 118 which, collectively, can receive the cog structure 138 of shaft assembly 130. The hollow region can be defined through a central region of post 117 proximate an interior side surface or wall of post 117.

The bottom base surface defining base indentation 118 can optionally include an instruction 119 illustrating or describing operation of the dispenser 100. In some examples, the instruction 119 may comprise a description related to the number of base 110 rotations relative to body 120 to administer an amount or dose of material (e.g., two rotation movements equal to 180 degrees of rotation relative to body 120 to administer a single amount or dose of material). Base 110 can further comprise at least one base index mark 113 defined between the exterior and interior base walls. In some examples, body 120 can comprise at least one body index mark 123 that aligns with the at least one base index mark 113 to mark a degree of rotation of base 110 relative to the body 120 (e.g., base and body index marks 113, 123 can be aligned at the 0/360-degree, 90-degree, 180-degree, or 270-degree rotations to indicate that a dose or number of doses of material have been completely administered).

Referring now to FIGS. 2C, 3, and 5A through 7, dispenser 100 can further comprise a body 120 rotatably couplable to base 110 as illustrated particularly in FIGS. 5A and 5B. In operation, base 110 can be rotated relative to body 120 which enables material extrusion from the body 120 through the lid 160 during operation of dispenser 100. Body 120 can comprise a generally rectangular prismatic or cuboid geometry to match the geometry of base 110. In other examples, body 120 can comprise other geometries as described previously with respect to base 110. As with base 110, body 120 can comprise a thin-walled structure having an exterior body wall opposite an interior body wall with similar thickness dimensions. Body 120 can extend between a first body end 122a and a second body end 122b, with a chamber 124 defined between the first and second body ends 122a,b. Chamber 124 can be configured to receive or store a material that can be administered to an animal through lid 160. In some examples, chamber 124 can comprise a volume configured to hold approximately 50 to 500 grams of material. More specifically, chamber 124 can comprise a volume configured to hold approximately 50, 85, 100, 200, 300, 400, or 500 grams of material, for example. In other examples, chamber 124 can be configured to hold other material amounts less than or greater than this range.

Body 120 can further comprise a plate 126 arranged on an exterior surface of the first body end 122a. Plate 126 may include a cylindrical geometry with one or more hollow regions arranged around a circumference. Plate 126 may comprise a second plurality of protrusions 128 couplable to and arranged around the exterior surface of the first body end. The second plurality of protrusions 128 may extend outward from the first body end toward the hollow region 114 of base 110. In some examples, body 120 can comprise three protrusions 128 arranged equidistant or approximately equidistant around the exterior surface of the first body end 122a. In other examples, the number of protrusions 128 may be less than or greater than three, in conjunction with the number of protrusions 116 included with base 110, to change the predetermined amount or dose of material dispensed through lid 160. The second plurality of protrusions 128 can be integrally formed during initial manufacturing of body 120, or added to body 120 after initial manufacturing using any known fixation or coupling process (e.g., adhesives, welding, fasteners such as snap fits, magnets, staples, etc.).

The first and second pluralities of protrusions 116, 128 can be configured to interact during operation of dispenser 100. Interaction between the first and second pluralities of protrusions 116, 128 can create a visual, audible, or tactile indication coinciding with the rotation of base 110 relative to body 120, and the administration or extrusion of a predetermined amount or dose of material. For example, a fractional turn such as a quarter turn or 90-degree rotation of base 110 relative to body 120 can create a clicking or other visual, audible, or tactile indication, caused by contact between the first plurality of protrusions 116 against the second plurality of protrusions 128. In such examples, the base 110 can be configured to rotate in a single direction, for example in the clockwise direction, and to administer several predetermined amounts of material. The direction of rotation will generally depend on the type of threads used with shaft assembly 130 and plunger assembly 140 (e.g., right-handed or left-handed threads). Rotation in the opposite direction, for example the counterclockwise direction, can be resisted by the threading arrangement and the first and second pluralities of protrusions 116, 128.

In some examples, the body 120 can comprise one or more detents or protrusions, and the base 110 can comprise one or more detents or protrusions. For example, the body 120 can comprise a single detent and the base 110 can comprise a plurality of protrusions, or vice versa. In other examples, the body 120 can comprise a plurality of detents and the base 110 can comprise a single protrusion, or vice versa. Interaction between the detent(s) and protrusion(s) of the body 120 and the base 110 can provide visual, audible, or tactile feedback when the base 110 is rotated relative to the body 120. This can indicate administering a predetermined amount or dose of material from the metered dose material dispenser 100 to an animal.

Each predetermined amount or dose of material can correspond to the fractional turn or rotation of base 110, and the resulting clicking or other visual, audible, or tactile indication. This allows a user to measure the amount or dose of material administered based on the number of fractional turns or the number of visual, audible, or tactile indications, for example the number of clicking sounds or a tactile element, produced by dispenser 100.

In some examples, a user can determine that a complete dose of a predetermined amount or dose of material was administered or extruded from the dispenser 100, based on the alignment or lack of alignment between base and body index marks 113, 123. For example, dispenser 100 may comprise a base index mark 113 aligned with a first body index mark 123 to represent an unrotated or new dispenser 100, or an initial position of base 110 relative to body 120. A user can begin rotating base 110 from the initial position to the quarter or other fractional turn position represented by a second body index mark 123 (e.g., a position rotated 90 degrees from the initial or first position).

As base 110 is rotated between the initial and quarter or other-turn positions (e.g., second, third, and fourth positions relative to the first, initial position), material can be extruded or administered out of lid 160 until the base index mark 113 aligns with the second body index mark 123. Alignment between the base index mark 113 and the second body index mark 123 can indicate that a complete dose of a predetermined amount or dose of material has been administered. Body 120 can further comprise third and fourth body index marks 123 corresponding to further quarter-turns of base 110 and additional complete doses of predetermined amounts of material. A user can continue administering precise amounts of material based on the alignment between base and body index marks 113, 123, in addition to hearing or seeing visual, audible, or tactile indications caused by contact or interaction between the first and second pluralities of protrusions 116, 128. In some examples, a visual indication can be provided by alignment between the base and body index marks 113, 123 (e.g., alignment between the similarly shaped base 110 and body 120, for example alignment between the rectangular base 110 and the rectangular body 120).

In some examples, the predetermined amount or dose of material can be predefined by a manufacturer of dispenser 100. In other examples, the predetermined amount or dose of material can be determined by a user prior to administering material to an animal. The predetermined amount or dose of material can vary widely, and for example may be approximately 0.1 to 50 grams, and in some embodiments may be at least about 0.1, 0.25, at least about 0.5, at least about 1 or at least about 2 grams, and up to about 50, up to about 40, up to about 30, up to about 20 or up to about 10 grams. For certain animals, the predetermined amount or dose of material may range from approximately 0.25 to 2 grams, and may be about 0.5 grams in some examples. Accordingly, a predetermined amount or dose of material can be dispensed from the chamber 124 of body 120 through the lid 160 in response to each quarter turn or 90-degree rotation, or other non-quarter rotation, of base 110 relative to body 120.

In other examples, base 110 can be configured with different rotation arrangements such as half turns (approximately 180-degree rotation), third turns (approximately 120-degree rotation), sixth turns (approximately 60-degree rotation), or eighth turns (approximately 45-degree rotation) relative to body 120. Regardless of the rotation arrangement, interaction between the first and second pluralities of protrusions 116, 128 creates a visual, audible, or tactile indication during rotation of base 110. The visual, audible, or tactile indication during rotation enables a user to determine the precise amount or dose of material administered from dispenser 100 as well as the number of material doses administered based on the number of visual, audible, or tactile indications detected. For example, three quarter-turns or a 270-degree rotation of base 110 could produce three visual, audible, or tactile indications indicating separate doses of administered or extruded material. In some examples where the dose amount is 0.5 grams, three quarter-turns can correspond to 1.5 grams of material in total administered or extruded from the dispenser 100. Accordingly, a precise or known amount or dose of material can be provided to an animal using the above-described metered dose techniques.

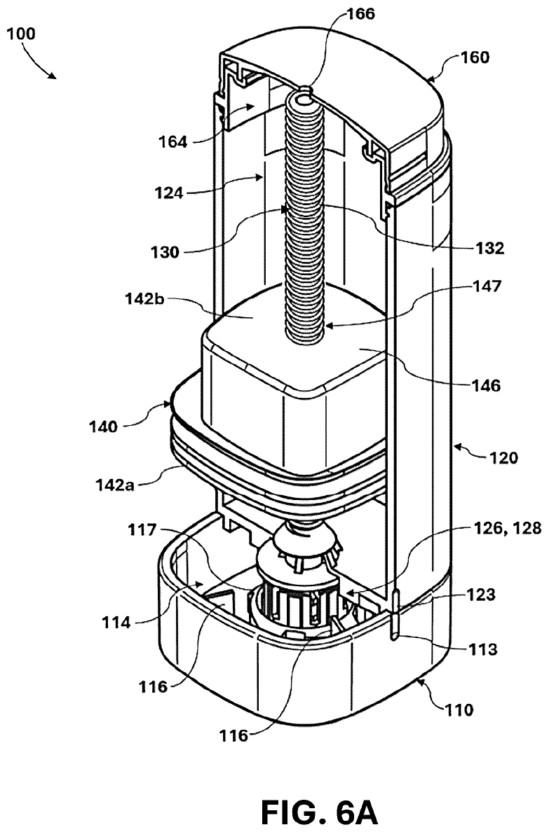

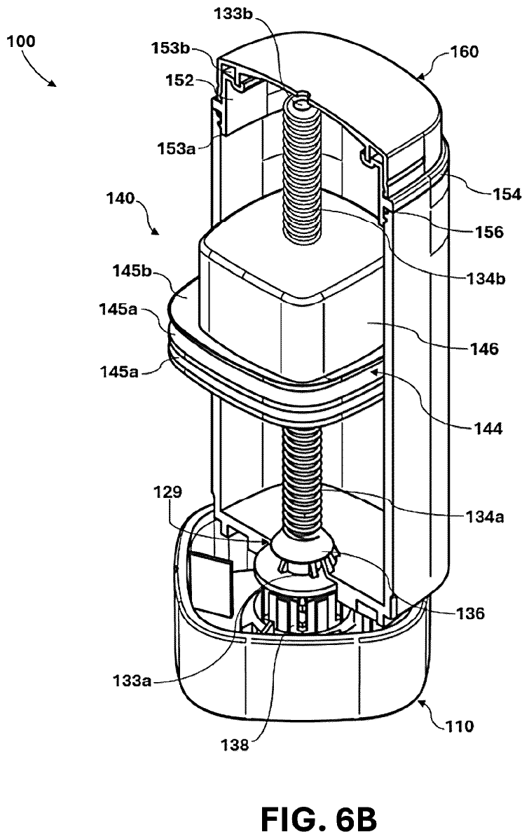

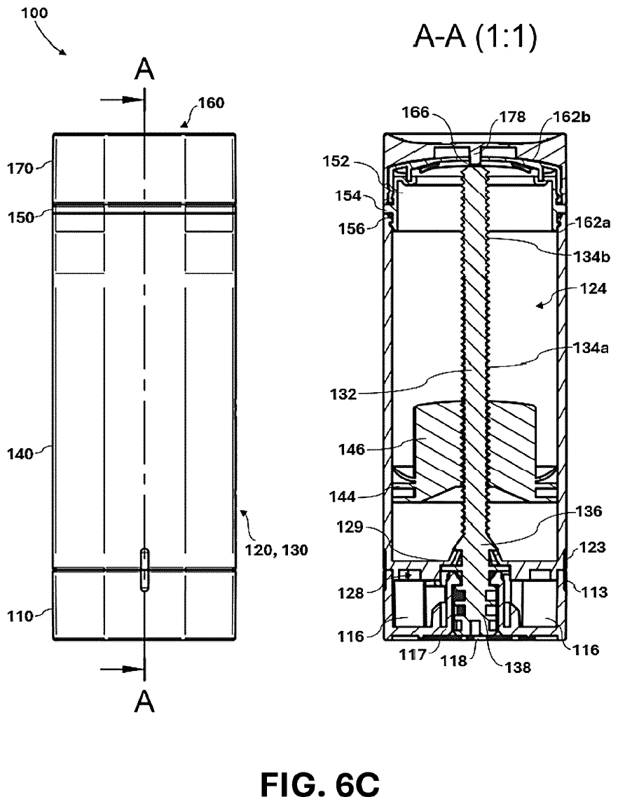

Body 120 may further comprise a body aperture 129 defined between the exterior surface of the first body end 122a and an opposing interior surface. This is illustrated particularly in FIGS. 6A through 6C. The body aperture 129 may be defined in a centrally located area and may be configured to receive post 117 when body 120 is coupled to base 110. In other examples, body aperture 129 may be defined in a non-centrally located area that is longitudinally aligned with a corresponding non-centrally located area of post 117. Body aperture 129 generally defines an internal diameter slightly greater than an outer diameter of post 117 to create a substantially tight fit between aperture 129 and post 117 when body 120 and base 110 are coupled or connected together.

Body 120 can be constructed from a variety of materials including polymers (e.g., polypropylene, polyethylene, polycarbonate, acrylonitrile butadiene styrene), metals (e.g., aluminum), ceramics, fibers, and composites thereof. Body 120 can be manufactured using any suitable subtractive or additive manufacturing process, for example extrusion processes like injection molding or additive manufacturing.

In some examples, the metered dose material dispenser 100 can include a rotary such as an intermediate finger wheel (not depicted) positioned along the body 120. The rotary or finger wheel can include a plurality of serrations along a periphery surface and can be configured to operate substantially the same as the base 110 (e.g., rotate to dispense material from the dispenser 100, provide an indication that an amount or dose of material was dispersed from the dispenser 100, and that the rotary or finger wheel was rotated relative to the body 120). The rotary or finger wheel can be rotated by a user in the same manner as with rotation of the base 110. The plurality of serrations can indicate one or more rotations of the rotary or finger wheel relative to the body 120.

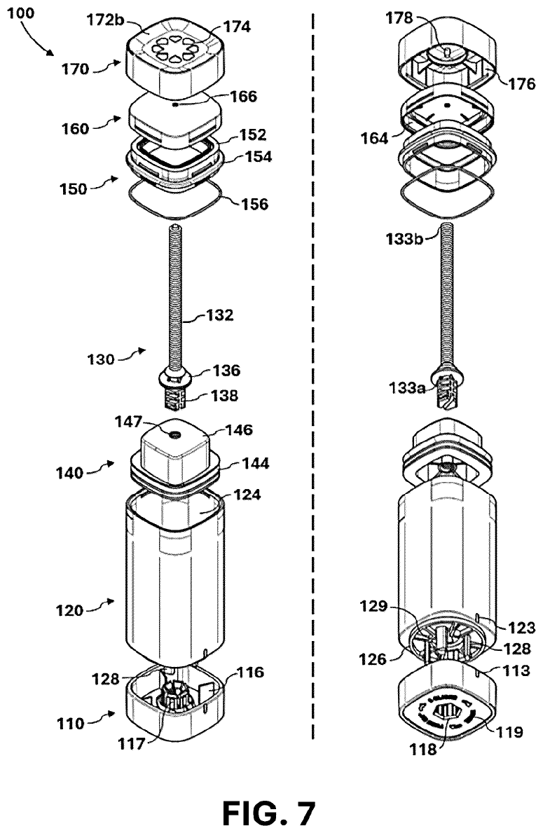

Referring now to FIGS. 6A through 7, dispenser 100 may further comprise a shaft assembly 130 and a plunger assembly 140 received within the chamber 124 of body 120. Shaft assembly 130 can comprise a shaft 132 extending between a first shaft end 133a and a second shaft end 133b. In some examples, shaft 132 can comprise a rotatable element such as an elongated screw. In some examples, shaft 132 can be threaded entirely between the first and second shaft ends 133a,b without defining an unthreaded portion. In other examples, shaft 132 can be unthreaded entirely between the first and second shaft ends 133a,b. In other examples, shaft 132 can define one or more threaded portions and one or more unthreaded portions between the first and second shaft ends 133a,b.

Shaft assembly 130 can further comprise a shaft coupler 136 proximate to or arranged around the second shaft end 133b, and a cog structure 138 couplable to the shaft coupler 136. In some examples, cog structure 138 can be integrally couplable to shaft coupler 136 to form a unitary component. Generally, cog structure 138 can be received within post 117 to operably couple shaft assembly 130 to base 110. Shaft coupler 136 will generally cover post 117 when cog structure 138 is received therein. This is illustrated particularly in FIGS. 6A through 6C. Accordingly, rotation of base 110 relative to body 120 enables simultaneous rotation of shaft assembly 130 in the same direction (e.g., the clockwise rotational direction when viewed facing base 110 or the counterclockwise rotational direction when viewed facing away from base 110, for example facing lid 160 or cover 170).

Plunger assembly 140 can extend between a first plunger end 142a and a second plunger end 142b within the chamber 124 of body 120. Plunger assembly 140 can comprise a plunger aperture 147 defined between the first and second plunger ends 142a,b, with shaft 132 of the shaft assembly 130 extending through the plunger aperture 147. This enables translation or movement of the plunger assembly 140 between the first and second ends 133a,b of shaft 132 during rotation of the base 110 relative to the body 120. Shaft assembly 130 rotates simultaneously with base 110 which enables corresponding movement of the plunger assembly 140 along the shaft 132. In some examples, plunger aperture 147 may comprise internal threads corresponding to external threads of shaft 132. Shaft assembly 130 can be configured to rotate similarly if a rotary or finger wheel is used in place of base 110.

Plunger assembly 140 can further comprise an annular member 144 having two or more annular lips 145a and a domed structure 145b. The two or more annular lips 145a and the domed structure 145b can be integrally couplable in some examples or removably couplable in other examples. Plunger assembly 140 can further comprise a generally rectangular plunger plug 146 extending outward from the domed structure 145b. The combination of plunger plug 146 and annular member 144 can push or force material through chamber 124 when base 110 is rotated. Plunger assembly 140 can be positioned at an initial position prior to use of dispenser 100. The initial position can be proximate the first body end 122a. Plunger assembly 140 can be translated or moved through chamber 124 to a final position after all material in chamber 124 has been administered or dispensed through lid 160. The final position can be proximate the second body end 122b. Plunger assembly 140 can be located at a plurality of intermediate positions between the initial and final position. Movement from one position to another represents the administering or extruding of a predetermined amount or dose of material out of the dispenser 100.

Plunger assembly 140 can be translated or moved through chamber 124 along shaft 132 until a top, end surface of plunger plug 146 proximate second body end 122b contacts an interior surface of lid 160, positioned external to body 120. At this point, base 110 is generally unable to rotate further despite the continued contact between plunger assembly 140 and the threaded shaft 132. Discontinued rotation can represent the exhaustion of all material originally provided into chamber 124 (e.g., all material in chamber 124 having been administered or dispensed out of the dispenser 100). Discontinued rotation can also be represented by a final alignment between base and body index marks 113, 123 and a lack of visual, audible, or tactile indications emitted by dispenser 100 from contact between the first and second pluralities of protrusions 116, 128. In examples where a rotary or finger wheel is used in place of base 110, the rotary or finger wheel may include index marks, optionally represented by a plurality of serrations, that can align with body index marks 123 to indicate discontinued rotation.

Plunger assembly 140 can be constructed from a variety of materials including polymers (e.g., polypropylene, polyethylene, polycarbonate, acrylonitrile butadiene styrene), metals (e.g., aluminum), ceramics, fibers, and composites thereof. Plunger assembly 140 can be manufactured using any suitable subtractive or additive manufacturing process, for example extrusion processes like injection molding or additive manufacturing.

Referring now to FIGS. 1A, 1B, 2C, 3, and 4B through 7, dispenser 100 can further comprise a bezel assembly 150 positioned between body 120 and lid 160. Bezel assembly 150 may comprise a bezel body 152 extending between a first bezel end 153a and a second bezel end 153b, an annular lip 154 surrounding the bezel body 152, and a ring 156 surrounding the bezel body 152 in a position underneath the annular lip 154 (e.g., underneath the annular lip 154 proximate the body 120 and distal from the lid 160). The second end 153b of bezel body 152 is generally received within chamber 124 of body 120, while the first bezel end 153a is generally received within lid 160. The annular lip 154 can extend outward from an outer circumference of bezel body 152 and can define opposing end surfaces that are generally planar (e.g., a first annular lip end surface can be facing first body end 122a and a second annular lip end surface can be facing second body end 122b). A first bezel body end surface can contact an opposing end surface of body 120, and a second bezel body end surface can contact an opposing end surface of lid 160. This is illustrated particularly in FIGS. 6A through 6C. Ring 156 can be placed in contact with the first bezel body end surface and thus received within chamber 124 of body 120 (like the second bezel end 153b of bezel body 152). In operation, bezel assembly 150 can provide a tight interface to couple or connect body 120 and lid 160 together to enable material extrusion through dispenser 100.

Bezel assembly 150 can be constructed from a variety of materials including polymers (e.g., polypropylene, polyethylene, polycarbonate, acrylonitrile butadiene styrene), metals (e.g., aluminum), ceramics, fibers, and composites thereof. Bezel assembly 150 can be manufactured using any suitable subtractive or additive manufacturing process, for example extrusion processes like injection molding or additive manufacturing.

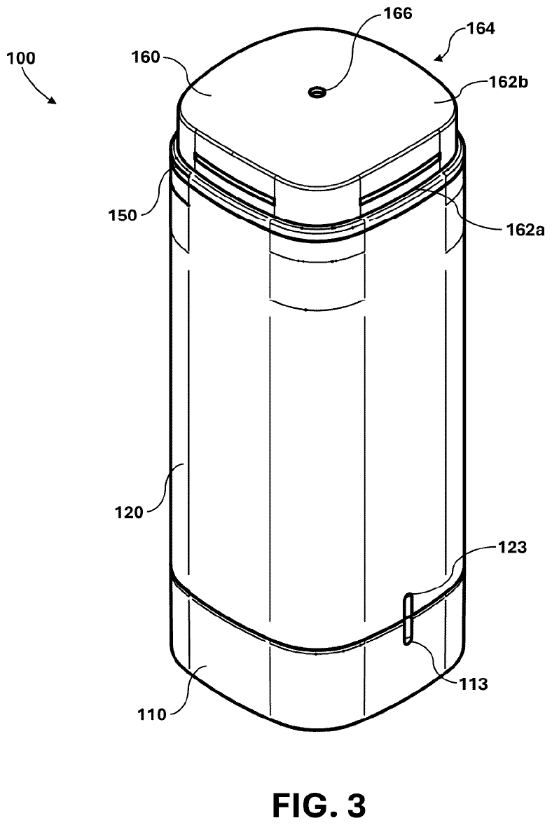

Referring now to the FIGURES generally, dispenser 100 can further comprise a lid 160 couplable to the body 120 and to the bezel assembly 150 (shown in FIGS. 3 and 4A through 7, for example), and an optional cover 170 positioned over the lid 160 when dispenser 100 is not in use (shown in FIGS. 1A through 2A, 2C, 6C, and 7, for example). Cover 170 can be sized and designed to fit tightly over lid 160 when used with dispenser 100. In some examples, one or more of body 120, bezel assembly 150, and lid 160 can be integrally coupled (e.g., body 120 and lid 160 can comprise a single unitary component). In some examples, lid 160 can be characterized as a material dispensing lid or cap placed over body 120 and configured to dispense material from the body 120 to an animal.

Lid 160 generally has a rectangular prismatic or cuboid geometry extending between a first, open lid end 162a and a second, closed lid end 162b. In other examples, lid 160 can comprise a generally cylindrical, triangular, conical, pyramidal, spherical, or other polygonal geometry. Lid 160 generally comprises a thin-walled structure having an exterior lid surface or wall and an interior lid surface or wall (e.g., exterior lid surface or wall facing way from body 120 and being closed, interior lid surface or wall facing toward body 120 and being open). Lid 160 generally comprises a hollow region 164 extending between the first and second lid ends 162a,b. Lid 160 can be constructed from a variety of materials including polymers (e.g., polypropylene, polyethylene, polycarbonate, acrylonitrile butadiene styrene), metals (e.g., aluminum), ceramics, fibers, and composites thereof. Lid 160 can be manufactured using any suitable subtractive or additive manufacturing process, for example extrusion processes like injection molding or additive manufacturing.

Lid 160 can include one or more material dispensing apertures 166 in the second lid end 162b, for example a single material dispensing aperture 166 in a central location on the second lid end 162b. In other examples, lid 160 can define two or more material dispensing apertures 166 arranged in any suitable pattern on the second lid end 162b. In other examples, lid 160 can define a permeable portion (not depicted) through which material can be dispensed or extruded. The permeable portion may include a plurality of individual pores, for example hundreds or thousands of individual pores through which material can be dispensed or extruded.

The one or more material dispensing apertures 166 can be coupled to the hollow region 164 defined between the first and second lid ends 162a,b. The hollow region 164 can be coupled to the chamber 124 of body 120 such that material can be forced or pushed through the body 120, using the plunger assembly 140, and extruded from the one or more material dispensing apertures 166. Alternatively, material can be extruded or dispersed through a permeable portion included with lid 160. Specifically, a single rotation of base 110 relative to body 120 can enable a predetermined amount or quantity of material to be forced or pushed through the chamber 124 of body 120, into the hollow region 164 of lid 160, and out of the one or more material dispensing apertures 166 or permeable portion for consumption by an animal.

When dispenser 100 is not in use, cover 170 can optionally be placed over lid 160 to block the material dispensing aperture(s) 166 or permeable portion. This can advantageously prevent accidental or inadvertent material extrusion from dispenser 100. Cover 170 generally has a rectangular prismatic or cuboid geometry extending between a first, open cover end 172a and a second, closed cover end 172b. Cover 170 generally has a geometry larger than lid 160 so that cover 170 can surround lid 160 when used with dispenser 100. Cover 170 generally comprises a thin-walled structure having an exterior cover surface or wall opposite an interior cover surface or wall. Cover 170 generally comprises a hollow region 176 extending between the first and second cover ends 172a,b. Cover 170 can be constructed from a variety of materials including polymers (e.g., polypropylene, polyethylene, polycarbonate, acrylonitrile butadiene styrene), metals (e.g., aluminum), ceramics, fibers, and composites thereof. Cover 170 can be manufactured using any suitable subtractive or additive manufacturing process, for example extrusion processes like injection molding or additive manufacturing.

Hollow region 176 of cover 170 can be configured to surround lid 160 when dispenser 100 is not in use. Cover 170 may include at least one post or peg 178 extending from the interior cover surface or wall. The at least one post or peg 178 can extend into the one or more material dispensing apertures 166 or permeable portion to block further material extrusion through each aperture 166 or the entire permeable portion. Cover 170 may also include a pattern or other design 174 on the exterior cover surface or wall at the second cover end 172b for aesthetic purposes (e.g., a logo or an instruction for using dispenser 100).

In some examples, the material received or stored within chamber 124 can comprise a thickened liquid, a gel, or a paste. In some examples, the material can comprise at least one supplement, for example joint supplements, multivitamins, biotin, calcium, chondroitin, coenzyme Q10, glucosamine, iron, omega-3 fatty acids, probiotics, taurine, vitamin B complex, vitamin C, vitamin D, vitamin E, and zinc.

In some examples, the material can comprise at least one medicament or drug, for example antibiotics, antifungals, dewormers, and heart medications. Other example medicaments include amoxicillin, benazepril, ciprofloxacin, doxycycline, enalapril, fenbendazole, griseofulvin, hydrochlorothiazide, ivermectin, ketoconazole, loperamide, metronidazole, nitrofurantoin, omeprazole, praziquantel, quinidine, ranitidine, sulfamethoxazole, thyroxine, ursodiol, various vitamins, warfarin, xylazine, yohimbine, and zoledronic acid. Other medicaments include various cannabinoids (e.g., cannabidiol (CBD), cannabinol (CBN), cannabigerol, (CBG), cannabichromene (CBC), cannabielsoin (CBE), cannabicyclol (CBL), cannabicitran (CBT), cannabichromanone (CBCN), cannabinodiol (CBND), tetrahydrocannabivarin (THCV), and related compounds).

In some examples, the material can comprise at least one animal feed, for example commercial feeds, meats, meat-by-products, vegetables, grains, cooked eggs, green-lipped mussel extract, a probiotic blend, and other common animal feeds that can be orally administered.

In some examples, the material can comprise at least one gel carrier for administering a supplement, medicament, or animal feed. Administering medicaments in a gel carrier can significantly improve compliance and ease the process for both animals and owners. The gel carrier can mask the taste of the medicament, making it more palatable for animals. Additionally, gel carriers are often easier to dose accurately and can be tailored to individual animal needs. Example gel carriers include aloe vera gel, carbomer gel, cellulose gel, collagen gel, hyaluronic acid gel, methylcellulose gel, poloxamer gel, sodium alginate gel, tragacanth gel, and xanthan gum gel.

In some examples, the material can comprise aromas, pheromones, and other similar extrudable or dispersible materials. The material can generally comprise any consumable liquid, gel, or paste substance where accurate measurements of administered quantities are advantageous.

Other ingredients that may be regarded as being supplements or medicaments include psyllium, coconut oil, slippery elm extract, broad-spectrum hemp extract, L-lysine, cranberry extract, Oregon grape root, quercetin, astragalus extract, calcium, potassium, sodium, chloride, magnesium, iron, manganese, iodine, vitamin A, vitamin D, vitamin E, thiamine (vitamin B1), riboflavin (vitamin B2), niacin, pyridoxine (vitamin B6), folic acid, vitamin B12, omega 3 fatty acids, omega 6 fatty acids, and omega 9 fatty acids.

Other ingredients that may be regarded as being supplements or medicaments include amino acid analogues of the proteinogenic amino acids L-glutamate and L-glutamine; amino acids that attach to a protein in the brain known as a GABA receptor; tryptophan (also called L-tryptophan, L-trypt, L-2-amino-3-(indole-3-yl) propionic acid, or L-tryptophane) and related analogs such as 5-hydroxytryptophan (5-HTP); compounds that modulate receptors for acetylcholinesterase, butyrylcholinesterase, or the serotonin (5-hydroxytryptamine or 5-HT) receptors 5-HT1 or 5-HT2; one or more extracts or ground portions (other than the previously-mentioned receptor modulators) of certain medicinal plants, tree barks and roots; compounds that metabolize monoamines, as well as compounds that increase norepinephrine, dopamine, and serotonin levels in the body of an animal; Ginseng; Boswellia serrata (herbal extract taken from the Boswellia serrata tree, also known as Indian frankincense); turmeric; and methylsulfonylmethane (MSM). Further description of these active agents and others are provided in commonly owned U.S. patent application Ser. No. 17/971,462 to Mayberry et al., published as U.S. Pat. Publ. No. 2023/0056488, the disclosure of which is hereby incorporated by reference herein in its entirety.

Other ingredients that may be regarded as active or inactive ingredients include ascorbic acid (vitamin C), cetyl alcohol, coco nucifera (coconut) oil, deionized water, Glycine soja (soybean) oil, lecithin, molasses, Nepeta cataria (catnip) extract, Plantago psyllium husk powder, potassium sorbate (preservative), salmon flavor, sodium methylcellulose, wild Alaskan salmon oil, xanthan gum, corn syrup, soybean oil, malt syrup, fish oil, cane molasses, sodium propionate (preservative), sodium benzoate (preservative), tocopherol, gelatin, citric acid, l-lysine monohydrochloride, stearic acid, cetyl alcohol, methylparaben (preservative), carboxymethylcellulose, and ascorbic acid.

In some examples, the material can be flavored, for example salmon flavored. Other common flavors used with animal-consumed items are also contemplated by the present disclosure (e.g., chicken flavor, beef flavor, pork flavor, cheese flavor, turkey flavor, duck flavor, liver flavor).

### Example 1

Set out below in Table 1 are ingredients that can be combined and dispensed from the disclosed metered dose material dispensers to prevent or resolve digestive issues, for example to prevent and eliminate hair or furballs. The ingredients are separated between active ingredients and other ingredients. The other ingredients may be adjusted as needed to obtain appropriate taste, viscosity, shelf life, and other desired properties.

TABLE 1

| | Other Ingredients |
|---|---|
| Active Ingredients (~22.5 mg) | (~477.5 mg, adjustable) |
| Psyllium Husk (~3.75 mg) | Ascorbic Acid (Vitamin C) |
| Coconut Oil (~12.5 mg) | Cetyl Alcohol |
| Slippery Elm Extract (~6.25 mg) | Coco Nucifera (Coconut) Oil |
| — | Deionized Water |
| — | Glycine Soja (Soybean) Oil |
| — | Lecithin |
| — | Molasses |
| — | Nepeta Cataria (Catnip) Extract |
| — | Plantago Psyllium Husk Powder |
| — | Potassium Sorbate |
| — | Salmon Flavor |
| — | Sodium Methylcellulose |
| — | Wild Alaskan Salmon Oil |
| — | Xanthan Gum |

### Example 2

Set out below in Table 2 are ingredients that can be combined and dispensed from the disclosed metered dose material dispensers to prevent or resolve skin and seasonal allergy issues, for example to support skin health for animals with sensitive skin. The ingredients are separated between active ingredients and other ingredients. The other ingredients may be adjusted as needed to obtain appropriate taste, viscosity, shelf life, and other desired properties.

TABLE 2

| | Other Ingredients |
|---|---|
| Active Ingredients (~38 mg) | (~462 mg, adjustable) |
| Quercetin (~2 mg) | Corn Syrup |
| Astragalus Extract (~4 mg) | Soybean Oil |
| Calcium (~0.08 mg) | Malt Syrup |
| Potassium (~0.275 mg) | Water |
| Sodium (~0.6 mg) | Fish Oil |
| Chloride (~0.125 mg) | Cane Molasses |
| Magnesium (~0.03 mg) | Sodium Propionate |
| | (preservative) |
| Iron (~0.4 mg) | Potassium Sorbate |
| | (preservative) |
| Manganese (~0.075 mg) | Sodium Benzoate |
| | (preservative) |
| Iodine (~0.04 mg) | Tocopherol |
| Vitamin A (~61 IU) | Gelatin |
| Vitamin D (~4.5 IU) | Citric Acid |
| Vitamin E (~0.4 IU) | — |
| Thiamine (Vitamin B1) (~0.125 mg) | — |
| Riboflavin (Vitamin B2) (~0.0008 mg) | — |
| Pyridoxine (Vitamin B6) (~0.06 mg) | — |
| Vitamin B12 (~0.15 mcg) | — |
| Niacin (~0.15 mg) | — |
| Folic Acid (~0.015 mg) | — |
| Omega 3 Fatty Acids (~3.5 mg) | — |
| Omega 6 Fatty Acids (~17.5 mg) | — |
| Omega 9 Fatty Acids (~9 mg) | — |

### Example 3

Set out below in Table 3 are ingredients that can be combined and dispensed from the disclosed metered dose material dispensers to promote animal vitality, for example to support urinary tract and normal urine pH. The ingredients are separated between active ingredients and other ingredients. The other ingredients may be adjusted as needed to obtain appropriate taste, viscosity, shelf life, and other desired properties.

TABLE 3

| Active Ingredients | Other Ingredients |
|---|---|
| (~25.8 mg) | (~474.2 mg, adjustable) |
| L-Lysine (~20.8 mg) | Water |
| Cranberry Extract (~3 mg) | L-Lysine Monohydrochloride |
| Oregon Grape Root (~2 mg) | Stearic Acid |
| — | Soybean Oil |
| — | Cetyl Alcohol |
| — | Lecithin |
| — | Salmon Flavor |
| — | Methylparaben (preservative) |
| — | Potassium Sorbate (preservative) |
| — | Sodium Benzoate (preservative) |
| — | Carboxymethylcellulose |
| — | Ascorbic Acid |
| — | Xanthan Gum |

A fourth example material for use with a metered dose material dispenser of the present disclosure can include the same active and other ingredients as in Example 1, in addition to comprising CBD from broad-spectrum hemp extract (e.g., approximately 2 grams of CBD). The fourth example material can be used to prevent or resolve digestive issues, for example to prevent and eliminate hair or furballs.

A fifth example material for use with a metered dose material dispenser of the present disclosure can include the same active and other ingredients as in Example 2, in addition to comprising CBD from broad-spectrum hemp extract (e.g., approximately 2 grams of CBD). The fifth example material can be used to prevent or resolve skin and seasonal allergy issues, for example to support skin health for animals with sensitive skin.

A sixth example material for use with a metered dose material dispenser of the present disclosure can include the same active and other ingredients as in Example 3, in addition to comprising CBD from broad-spectrum hemp extract (e.g., approximately 2 grams of CBD). The sixth example material can be used to promote animal vitality, for example to support urinary tract and normal urine pH.

A seventh example material for use with a metered dose material dispenser of the present disclosure can include the same active and other ingredients as in Example 1, in addition to comprising broad-spectrum hemp extract (e.g., approximately 2 grams of hemp extract). The seventh example material can be used to prevent or resolve digestive issues, for example to prevent and eliminate hair or furballs.

An eighth example material for use with a metered dose material dispenser of the present disclosure can include the same active and other ingredients as in Example 2, in addition to comprising broad-spectrum hemp extract (e.g., approximately 2 grams of hemp extract). The eighth example material can be used to prevent or resolve skin and seasonal allergy issues, for example to support skin health for animals with sensitive skin.

A ninth example material for use with a metered dose material dispenser of the present disclosure can include the same active and other ingredients as in Example 3, in addition to comprising broad-spectrum hemp extract (e.g., approximately 2 grams of hemp extract). The ninth example material can be used to promote animal vitality, for example to support urinary tract and normal urine pH.

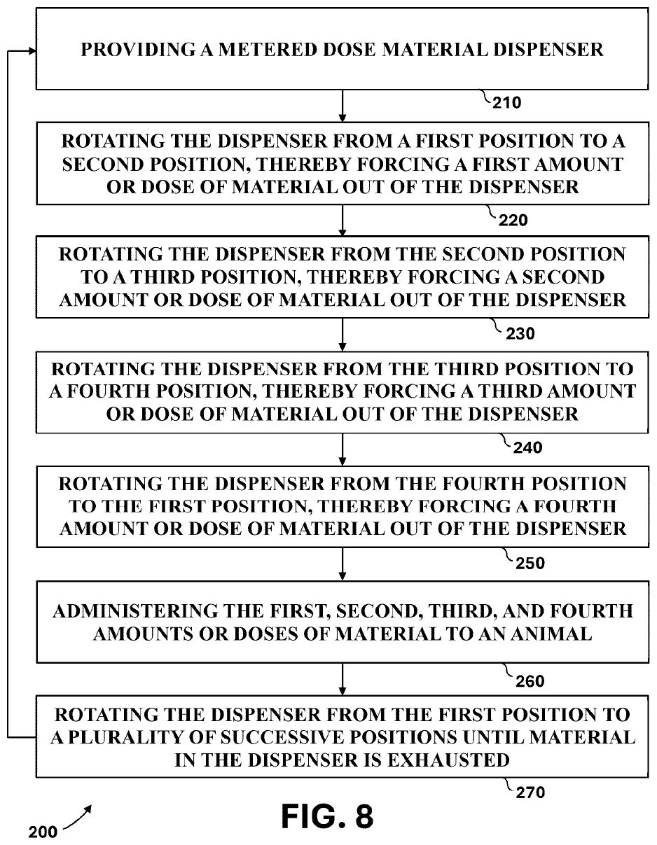

Referring now to FIG. 8, a method 200 of administering material to an animal using a metered dose material dispenser is depicted, according to examples of the present disclosure. Method 200 may use a metered dose material dispenser as described and illustrated herein for administering material to an animal according to the following steps or operations.

At 210, method 200 may include providing a metered dose material dispenser comprising a body extending between a first end and a second end and defining one or more apertures or a permeable portion at the second end, a base rotatably couplable to the body, a shaft couplable to the base, a plunger positioned within the body and couplable to the shaft, and a quantity of material positioned within the body proximate the plunger. The plunger can be configured to translate within the body in response to rotation of the shaft. Translation of the plunger forces a dose of the quantity of material through the body and out of the one or more apertures or the permeable portion. In some examples, the metered dose material dispenser of method 200 can be dispenser 100 as shown and described herein using any configuration or arrangement (e.g., lid 160 can define a single material dispensing aperture 162 or permeable portion, base 110 can be configured to rotate in fractional turns, such as quarter turns, relative to body 120).

In some examples, the metered dose material dispenser provided with method 200 can include an intermediate rotary actuator such as an intermediate finger wheel (not depicted) positioned along the body instead of the base. The rotary actuator can include a plurality of serrations along a periphery surface and can be configured to operate substantially the same as the base (e.g., rotate to dispense material from the dispenser, provide an indication that an amount or dose of material was dispersed from the dispenser, and show that the rotary actuator was rotated relative to the body). The rotary actuator can be rotated by a user in a manner similar to that used for rotation of the base. The plurality of serrations can indicate one or more rotations of the rotary or finger wheel relative to the body.

At 220, method 200 may include rotating the base or intermediate rotary actuator relative to the body from a first position to a second position, thereby causing the shaft to rotate and the plunger to translate within the body to force a first amount or dose of material out of the dispenser.

At 230, the method 200 may include rotating the base or intermediate rotary actuator relative to the body from the second position to a third position, thereby causing the shaft to rotate further and the plunger to translate further within the body to force a second amount or dose of material out of the dispenser. At 240, method 200 may include rotating the base or intermediate rotary actuator relative to the body from the third position to a fourth position, thereby causing the shaft to rotate further and the plunger to translate further within the body to force a third amount or dose of material out of the dispenser. At 250, method 200 may include rotating the base or intermediate rotary actuator dispenser relative to the body from the fourth position to the first position, thereby causing the shaft to rotate further and the plunger to translate further within the body to force a fourth amount or dose of material out of the dispenser.

At 260, method 200 may include administering the first, second, third, and fourth doses of material to an animal such as a cat, a dog, a horse, a cow, and any other animal requiring accurate administering of materials. The first, second, third, and fourth doses of material can be administered to the animal individually or with two or more doses of material in combination. For example, method 200 may comprise administering the first amount or dose of material to an animal, followed by extruding or generating the second and third doses of material from the dispenser and administering the second and third doses to the animal, followed by extruding or generating the fourth amount or dose of material from the dispenser and administering the fourth dose to the animal. Two or more of the first, second, third, and fourth doses of material can be administered in succession or with a time gap between successive doses. Various alternative arrangements of extruding/generating and administering doses of material are contemplated for method 200 and the metered dose material dispenser used to carry out the method.

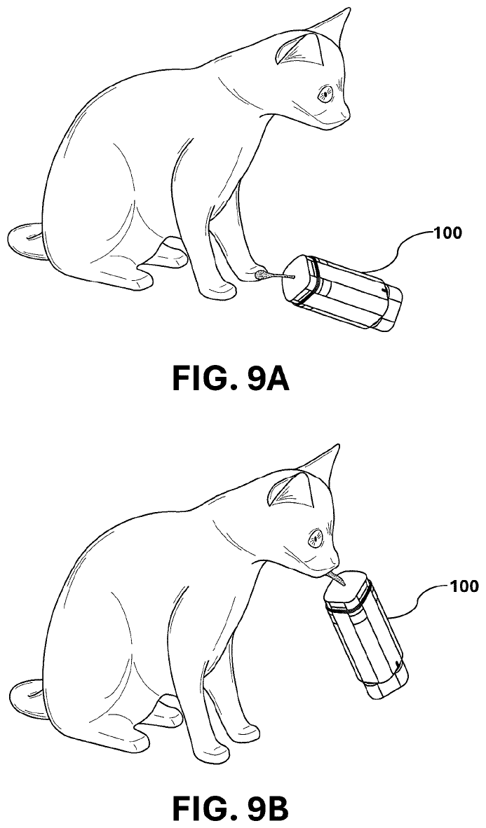

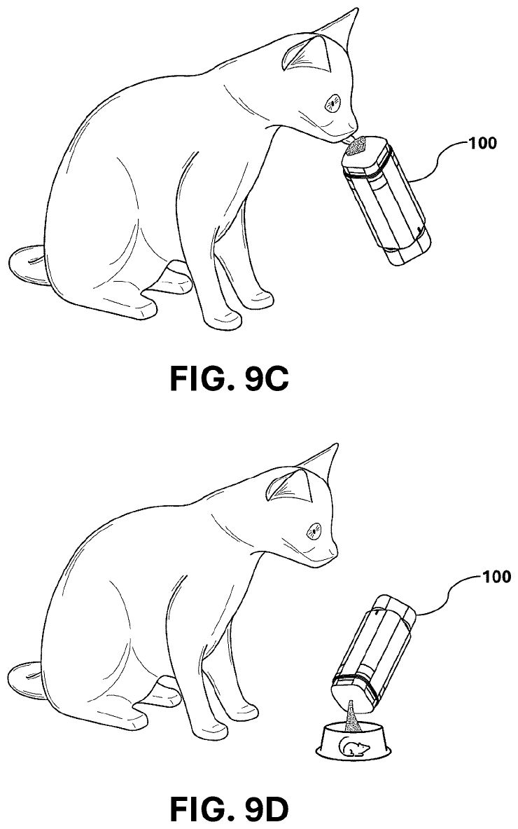

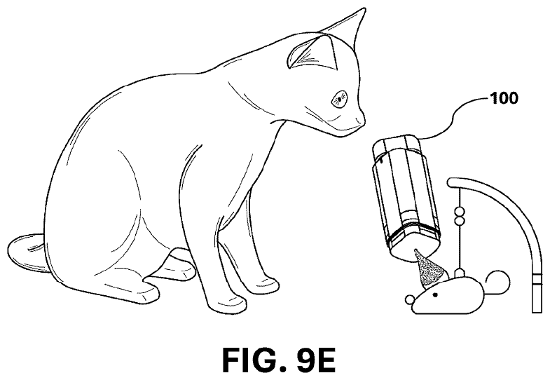

Referring now to FIGS. 9A through 9E, administering any one of the first, second, third, and fourth doses of material, or successive doses of material, may comprise the following: extruding the dose(s) of material from the dispenser and onto a body part of the animal (illustrated in FIG. 9A); extruding the dose(s) of material from the dispenser and into or around a mouth of the animal (illustrated in FIG. 9B); extruding the dose(s) of material from the dispenser and into a container such as a food bowl (illustrated in FIG. 9C); extruding the dose(s) of material from the dispenser and onto an animal toy (illustrated in FIG. 9D); and extruding the dose(s) of material from the dispenser and onto a surface of the dispenser, for example an external surface of the lid, and allowing the animal to consume the dose(s) off the surface (illustrated in FIG. 9E).

Other related techniques for administering doses of material from the dispenser to an animal are also contemplated by the present disclosure. For example, certain techniques suitable for cats or dogs may be unsuitable for cows or horses. The material administering or extruding technique used will generally depend at least partially on the type of animal cared for and their individual characteristics (e.g., size, age, speed, relationship to humans, material consumption requirements, and other relevant animal characteristics). It is contemplated by the present disclosure that animals of different sizes, for example a cat rather than a horse, may require different predetermined amounts of material to be administered from the dispenser. In such situations, the present disclosure contemplates changing the predetermined amount or concentration of ingredients in the material, or the quantity of material, within the dispenser to account for the intended animal that receives the material. This can be achieved, for example, by changing the size of the dispenser body to account for needing more space for the additional material, by changing the dispenser body diameter, or by changing the shaft thread pitch.

Referring back to FIG. 8, at 270, method 200 may include rotating the dispenser from the first position to a plurality of successive positions until the quantity of material in the body of the dispenser is exhausted or runs out. The plurality of successive positions may be equivalent to a plurality of second, third, and fourth positions until the quantity of material within the dispenser is exhausted. In some examples, method 200 can further include providing a new quantity of material into the body to replace the exhausted or extinguished quantity of material. The base or intermediate rotary actuator and the body may be removably couplable such that the chamber defined within the body can be accessed to replenish the quantity of material. The new quantity of material may be the same or may be different than the original quantity of material in regard to material composition and material quantity (e.g., replacing 85 grams of material supplement in an original quantity with 100 grams of medicament in a new quantity).

In some examples, the first, second, third, fourth, and successive dose(s) of material can be measured based on a visual, audible, or tactile indication emitted from contact between a first plurality of protrusions extending from the base of the dispenser and a second plurality of protrusions extending from the body of the dispenser. The visual, audible, or tactile indication can be similar to a clicking sound or can be in the form of a tactile element indicating an administered amount or dose of material. In some examples, the first, second, third, fourth, and successive dose(s) of material can comprise one or more of a supplement, a medicament, and animal feed. In some examples where base and body are removably couplable, a second, new quantity of material can replace a first, exhausted quantity of material in the dispenser. The first and second quantities of material can be the same or can be different.

Various examples of systems, devices, and methods have been described herein. These examples are given only by way of example and are not intended to limit the scope of the claimed inventions. It should be appreciated, moreover, that the various features of the examples that have been described may be combined in various ways to produce numerous additional examples. Moreover, while various materials, dimensions, shapes, configurations, geometries and locations, etc. have been described for use with disclosed examples, others besides those disclosed may be utilized without exceeding the scope of the claimed inventions.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood by persons of ordinary skill in the art. Moreover, elements described with respect to one example can be implemented in other examples even when not described in such examples unless otherwise noted.

Although a dependent claim may refer in the claims to a specific combination with one or more other claims, other examples can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of administering material to an animal, comprising:
providing a metered dose material dispenser including a body extending between a first end and a second end, a base or intermediate rotary actuator rotatably coupled to the body, a shaft coupled to the base or intermediate rotary actuator, a plunger positioned within the body and rotatably coupled to the shaft, and a quantity of material positioned within the body, wherein the plunger is configured to translate within the body in response to rotation of the shaft, wherein translation of the plunger forces an amount or dose of the quantity of material through one or more apertures defined in the body or through a permeable portion defined in the body and out of the dispenser;
rotating the base or intermediate rotary actuator relative to the body from a first position to a second position, thereby causing the shaft to rotate and the plunger to translate within the body to force a first amount or dose of material out of the dispenser; and
administering the first amount or dose of material to an animal.

2. The method of claim 1, wherein the base or intermediate rotary actuator comprises a first plurality of protrusions and the body comprises a second plurality of protrusions, wherein rotation of the base or intermediate rotary actuator relative to the body enables interaction between the first and second pluralities of protrusions, thereby providing visual, audible, or tactile feedback when the base or intermediate rotary actuator is rotated relative to the body.

3. The method of claim 1, wherein the metered dose material dispenser further comprises one or more detents and one or more protrusions, wherein interaction between a detent and a protrusion provides visual, audible, or tactile feedback when the base or intermediate rotary actuator is rotated relative to the body.

4. The method of claim 1, wherein the quantity of material comprises an animal supplement.

5. The method of claim 1, wherein the quantity of material comprises an animal medicament.

6. The method of claim 1, wherein the quantity of material comprises animal feed.

7. The method of claim 1, wherein administering the first amount or dose of material comprises at least one of:
extruding the first amount or dose of material onto a body part of the animal;
extruding the first amount or dose of material into or around a mouth of the animal;
extruding the first amount or dose of material into a container;
extruding the first amount or dose of material onto an animal toy; and
extruding the first amount or dose of material onto a surface of the dispenser and allowing the animal to consume the dose off the surface.

8. The method of claim 1, wherein the second position is offset from the first position by a fractional turn.

9. The method of claim 1, further comprising rotating the base or intermediate rotary actuator relative to the body from the second position to a plurality of successive positions until the quantity of material positioned within the body is exhausted.

10. The method of claim 1, wherein the base and the body are separable such that the quantity of material within the body can be accessed.

11. A method of administering material to an animal, comprising:
providing a metered dose material dispenser including a body extending between a first end and a second end, a base or intermediate rotary actuator rotatably coupled to the body, a shaft coupled to the base or intermediate rotary actuator, a plunger positioned within the body and rotatably coupled to the shaft, and a quantity of material positioned within the body proximate the plunger, wherein the plunger is configured to translate within the body in response to rotation of the shaft, wherein translation of the plunger forces an amount or dose of the quantity of material through one or more apertures defined in the body or through a permeable portion defined in the body and out of the dispenser;
rotating the base or intermediate rotary actuator relative to the body from a first position to a second position, thereby causing the shaft to rotate and the plunger to translate within the body to force a first amount or dose of material out of the dispenser;
rotating the base or intermediate rotary actuator relative to the body from the second position to a third position, thereby causing the shaft to rotate further and the plunger to translate further within the body to force a second amount or dose of material out of the dispenser;
rotating the base or intermediate rotary actuator relative to the body from the third position to a fourth position, thereby causing the shaft to rotate further and the plunger to translate further within the body to force a third amount or dose of material out of the dispenser; and
rotating the base or intermediate rotary actuator relative to the body from the fourth position to the first position, thereby causing the shaft to rotate further and the plunger to translate further within the body to force a fourth amount or dose of material out of the dispenser.

12. The method of claim 11, wherein the base or intermediate rotary actuator comprises a first plurality of protrusions and the body comprises a second plurality of protrusions, wherein rotation of the base or intermediate rotary actuator relative to the body enables interaction between the first and second pluralities of protrusions, thereby providing visual, audible, or tactile feedback when the base or intermediate rotary actuator is rotated relative to the body.

13. The method of claim 11, wherein the metered dose material dispenser further comprises one or more detents and one or more protrusions, wherein interaction between a detent and a protrusion provides visual, audible, or tactile feedback when the base or intermediate rotary actuator is rotated relative to the body.

14. The method of claim 11, wherein the quantity of material comprises an animal supplement.

15. The method of claim 11, wherein the quantity of material comprises an animal medicament.

16. The method of claim 11, wherein the quantity of material comprises animal feed.

17. The method of claim 11, wherein the second position is offset from the first position by a fractional turn, wherein the third position is offset from the second position by a fractional turn, wherein the fourth position is offset from the third position by a fractional turn, wherein the first position is offset from the fourth position by a fractional turn.

18. The method of claim 11, further comprising:
administering the first amount or dose of material to the animal;
administering the second amount or dose of material to the animal;
administering the third amount or dose of material to the animal; and
administering the fourth amount or dose of material to the animal,
wherein administering the first, second, third, and fourth amounts or doses of material to the animal occurs individually or with two or more amounts or doses of material in combination.

19. The method of claim 18, wherein administering the first, second, third, and fourth amounts or doses of material comprises at least one of:
extruding the amounts or doses onto a body part of the animal;
extruding the amounts or doses into or around a mouth of the animal;
extruding the amounts or doses into a container;
extruding the amounts or doses onto an animal toy; and
extruding the amounts or doses onto a surface of the dispenser and allowing the animal to consume the doses off the surface.

20. The method of claim 11, wherein the base and the body are separable such that the quantity of material within the body can be accessed.
